(19) United States
(12) Patent Application Publication
(10) Pub. No.: US 2012/0144062 A1
(43) Pub. Date: Jun. 7, 2012

(54) MPTCP And Mobile IP Interworking

(75) Inventors: Catherine Livet, Montreal (CA); Alexander Reznik, Titusville, NJ (US); Shamim Akbar Rahman, Cote St. Luc (CA); Juan Carlos Zuniga, Ville St. Laurent (CA)

(73) Assignee: InterDigital Patent Holdings, Inc., Wilmington, DE (US)

(21) Appl. No.: 13/152,762

(22) Filed: Jun. 3, 2011

Related U.S. Application Data
(60) Provisional application No. 61/351,719, filed on Jun. 4, 2010.
(60) Provisional application No. 61/363,010, filed on Jul. 9, 2010.

(51) Int. Cl. G06F 15/173

(52) U.S. Cl. 709/239

(57) ABSTRACT

Systems, methods, and instrumentalities are disclosed that provide coordination between MPTCP and mobile IP (MIP). An MPTCP session may be established between a mobile node and a correspondent node. MIP and simple IP subflows may be established in the MPTCP session. The mobile node may activate MIP and establish a first subflow via MIP. The first subflow may be associated with a first path that may be routed through a first home agent. The mobile node may deactivate MIP and establish a second subflow via simple internet protocol (IP). The second subflow may be associated with a second path that is not routed through a home agent.

### CROSS-REFERENCE TO RELATED APPLICATIONS

This application claims the benefit of U.S. Provisional Patent Application No. 61/351,719, filed on Jun. 4, 2010, and U.S. Provisional Patent Application No. 61/363,010, filed on Jul. 9, 2010, the contents of which are hereby incorporated by reference herein.

### BACKGROUND

The Multipath Transmission Control Protocol (MPTCP) is a research effort attempting to utilize multiple paths with one TCP session (subflow) per path, thus maximizing resource usage and increasing redundancy. Current systems and methods relating to an MPTCP session may cause an overreliance on sending the MPTCP session subflows through home agents.

### SUMMARY

Systems, methods, and instrumentalities are disclosed that may provide coordination between MPTCP and mobile IP (MIP). An MPTCP session may be established between a mobile node and a correspondent node. MIP and simple IP subflows may be established in the MPTCP session. The mobile node may activate MIP and establish a first subflow via MIP. The first subflow may be associated with a first path that may be routed through a first home agent. The mobile node may deactivate MIP and establish a second subflow via simple internet protocol (IP). The second subflow may be associated with a second path that is not routed through a home agent.

Subflows may be established based on a sensitivity associated with data to be transmitted. MIP may be considered more reliable than simple IP and may be used for more sensitive data. A threshold may be established (e.g., by a user, information provider, mobile node, correspondent node, etc.) to determine a subflow type to be established for data to be transmitted. For example, if a sensitivity of data is below the established threshold (e.g., the data is considered as not sensitive), the data may be transmitted via a subflow associated with simple IP. If a sensitivity of data is above the established threshold (e.g., the data is considered sensitive), the data may be transmitted via a subflow associated with MIP.

A failure may occur when transmitting data via simple IP (e.g., mobility may cause termination of the subflow due to loss of the IP address). For example, referring to the above example, a failure of the second subflow may be detected. In response, the mobile node may establish a third subflow via MIP. The third subflow may be associated with a third path that may be routed through the first home agent or a second home agent. The mobile node may transmit data associated with the failure via the third subflow.

A proxy TCP server may be used to receive MPTCP communications and transmit the received data to a correspondent node. The mobile node may detect the presence of a proxy TCP server associated with a correspondent node. The mobile node may establish subflows wherein the paths for the subflows include the proxy TCP server.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D illustrates an exemplary Mobile IP overview;

FIG. 2 illustrates an exemplary MPTCP Protocol Stack;

FIG. 3 illustrates an exemplary MPTCP session working with simple IP;

FIG. 4 illustrates an exemplary MPTCP session working with Mobile IP and using two Home Agents;

FIG. 5 illustrates an exemplary MPTCP and Mobile IP Stack;

FIG. 6 illustrates an exemplary situation where MIP HA may become a bottleneck for an MPCTP session;

FIG. 7 illustrates an exemplary dynamic mobile IP activation and deactivation call flow;

FIG. 8 illustrates an exemplary functional architecture for MPTCP;

FIG. 9 illustrates an exemplary mobile IP registration procedure;

FIG. 10 illustrates exemplary mobile IP IP tunneling;

FIG. 11 illustrates an exemplary MIP triangular routing environment;

FIG. 12 illustrates an exemplary end-to-end proxy MPTCP protocol stack;

FIG. 13 illustrates an exemplary proxy MPTCP call session; and

FIG. 14 illustrates an exemplary proxy MPTCP protocol stack.

### DETAILED DESCRIPTION

A detailed description of illustrative embodiments may now be described with reference to the Figures. However, while the present invention may be described in connection with exemplary embodiments, it is not limited thereto and it is to be understood that other embodiments may be used or modifications and additions may be made to the described embodiments for performing the same function of the present invention without deviating therefrom. In addition, the figures may illustrate call flows, which are meant to be exemplary. It is to be understood that other embodiments may be used. The order of the flows may be varied where appropriate. Also, flows may be omitted if not needed and additional flows may be added. Further, although the disclosed systems, methods, and instrumentalities may be generally illustrated herein with reference to MPTCT and MIP, the embodiments are not limited thereto.

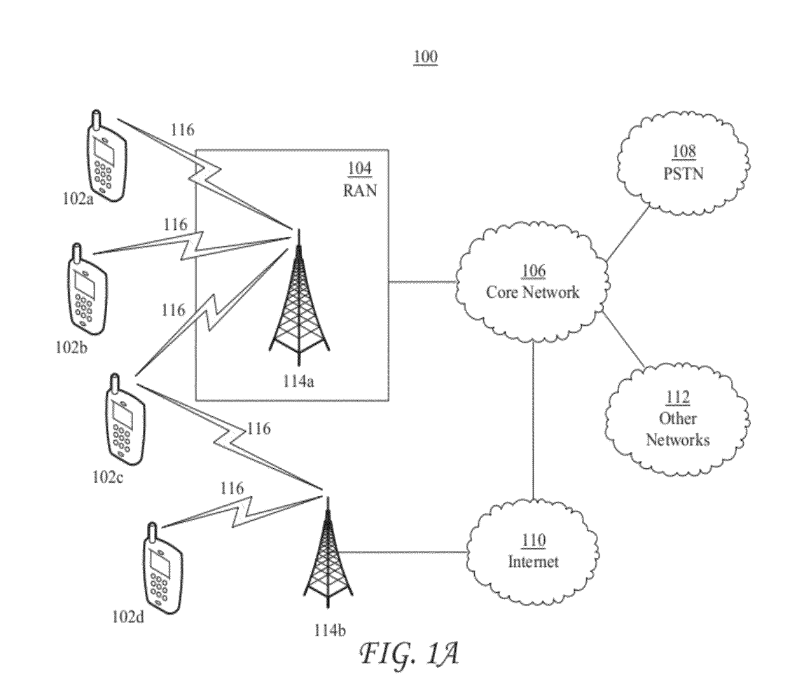

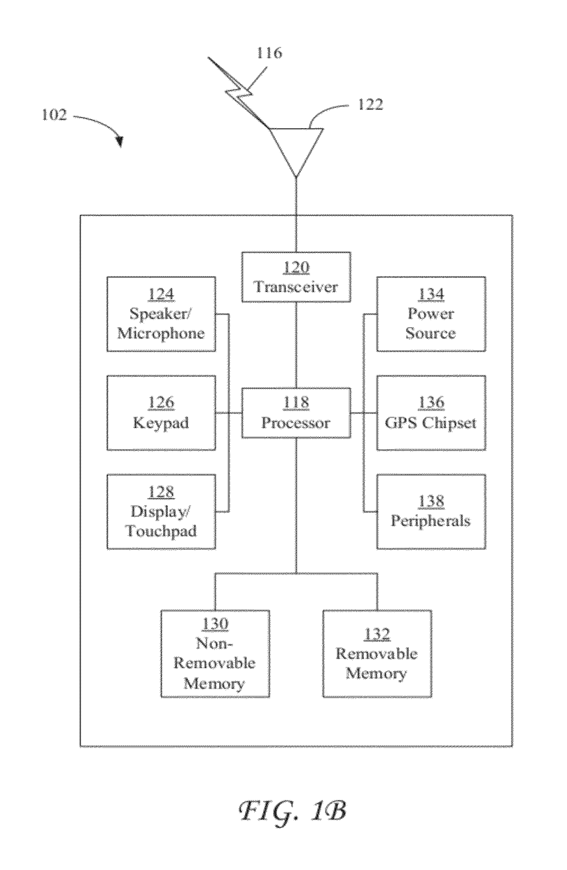

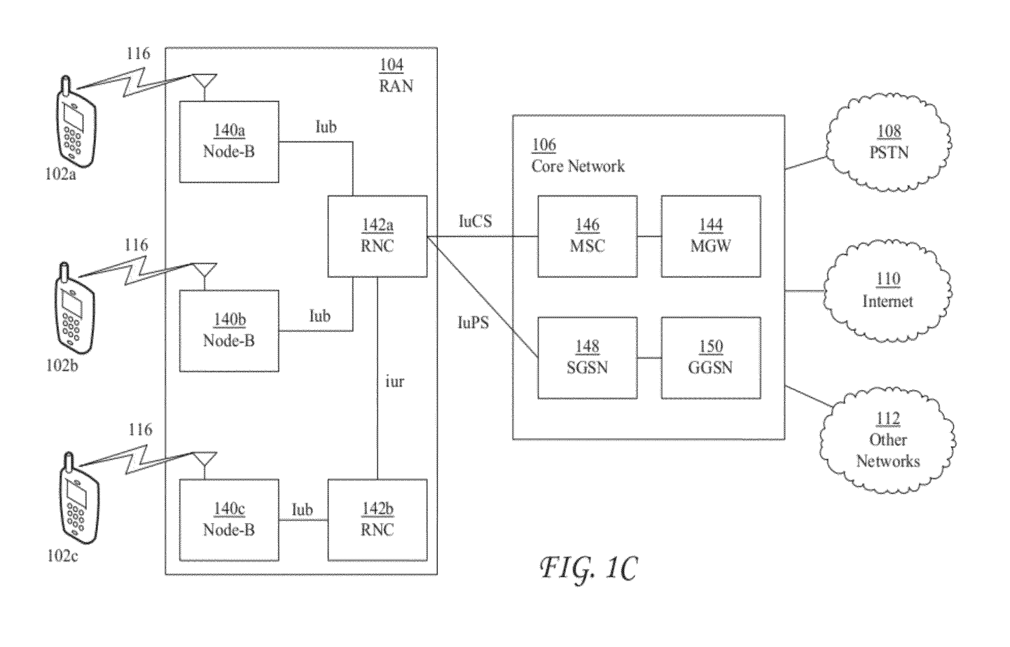

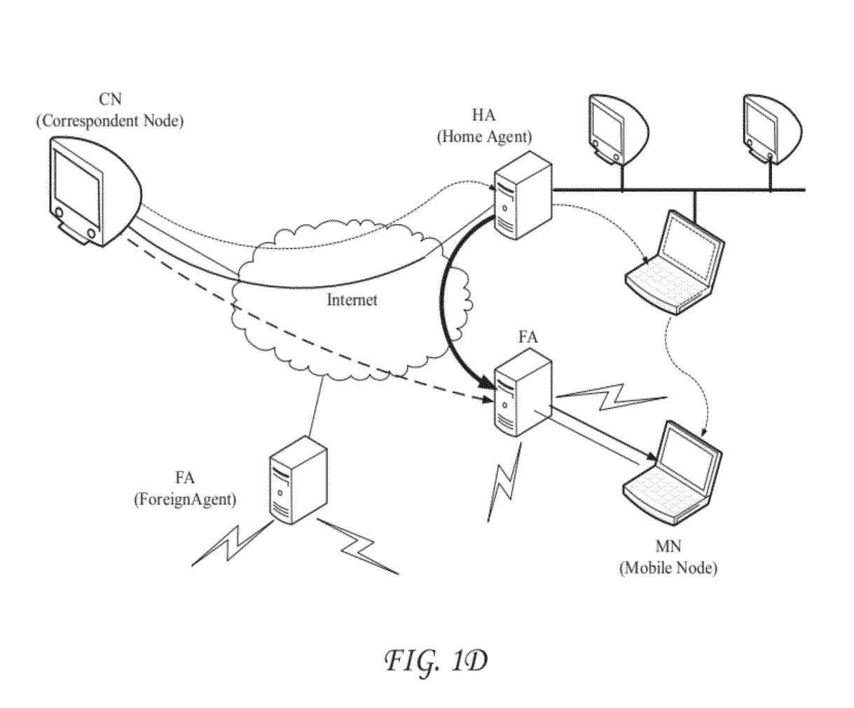

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Systems, methods, and instrumentalities are disclosed that may provide coordination between MPTCP and mobile IP (MIP). An MPTCP session may be established between a mobile node and a correspondent node. MIP and simple IP subflows may be established in the MPTCP session. The mobile node may activate MIP and establish a first subflow via MIP. The first subflow may be associated with a first path that may be routed through a first home agent. The mobile node may deactivate MIP and establish a second subflow via simple internet protocol (IP). The second subflow may be associated with a second path that is not routed through a home agent.

Subflows may be established based on a sensitivity associated with data to be transmitted, e.g., a mobility sensitivity. MIP may be considered more reliable than simple IP and may be used for more sensitive data. A threshold may be established (e.g., by a user, information provider, mobile node, correspondent node, etc.) to determine a subflow type to be established for data to be transmitted. For example, if a sensitivity of data is below the established threshold (e.g., the data is considered as not sensitive), the data may be transmitted via a subflow associated with simple IP. If a sensitivity of data is above the established threshold (e.g., the data is considered sensitive), the data may be transmitted via a subflow associated with MIP.

A failure may occur when transmitting data via simple IP (e.g., mobility may cause termination of the subflow due to loss of the IP address). For example, referring to the above example, a failure of the second subflow may be detected. In response, the mobile node may establish a third subflow via MIP. The third subflow may be associated with a third path that may be routed through a second home agent. The mobile node may transmit data associated with the failure via the third subflow.

A proxy TCP server may be used to receive MPTCP communications and transmit the received data to a correspondent node. The mobile node may detect the presence of a proxy TCP server associated with a correspondent node. The mobile node may establish subflows wherein the paths for the subflows include the proxy TCP server.

FIG. 1D illustrates an exemplary mobile IP (MIP) overview. Mobile IP (e.g., Mobile IPv4) may allow a mobile node to have two IP addresses by transparently maintaining a binding between the two addresses. One of the IP addresses is a permanent home address that may be assigned at the home network and may be used to identify communication endpoints. The other is a temporary care-of address (CoA) that may represent the current location of the host. Mobile IP may make mobility transparent to higher level protocols, while making minimum changes to the existing Internet infrastructure.

From the correspondent node (CN), the mobile node has a permanent IP address (home agent) and the mobile node has a local CoA (care-of address). In case of mobility where the mobile node has a new temporary address, the MIP client needs to inform the home agent (HA) of the CoA change so that the HA can re-route the packet to the new mobile node location. Mobile IP supports mobility by transparently binding the HA of the mobile node with its CoA.

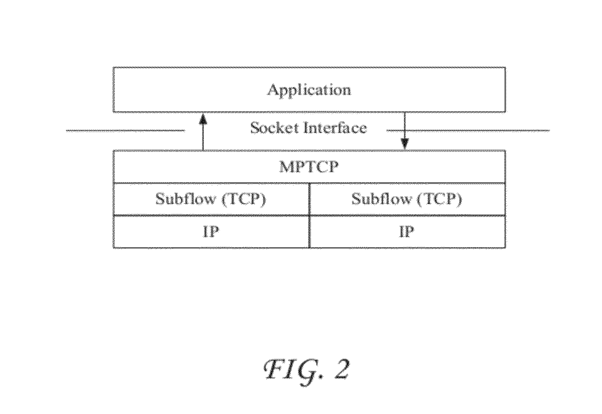

A multipath transmission control protocol (MPTCP), such as the IETF MPTCP may provide a capability for simultaneously using multiple paths in a regular TCP session. FIG. 2 illustrates an exemplary MPTCP Protocol Stack.

As referred to herein, the term path may refer to a sequence of wired or wireless links between a sender and a receiver, which may be represented by a source and destination address pair.

As referred to herein, the term subflow may refer to a stream of TCP packets sent over a path. A subflow may be a component part of a connection between two endpoints.

As referred to herein, the term connection may refer to a collection of one or more subflows, over which an application can communicate between two endpoints. There may be a one-to-one mapping between a connection and a socket.

As referred to herein, the term data-level may refer to payload data that may be nominally transferred over a connection, which in turn may be transported over subflows (the term “data-level” may be synonymous with “connection level,” in contrast to “subflow-level” which may refer to properties of an individual subflow).

As referred to herein, the term token may refer to a locally unique identifier given to a multipath connection by an endpoint (may also be referred to as a “Connection ID”).

As referred to herein, the term endpoint may refer to a host operating an MPTCP implementation and either initiating or terminating a MPTCP connection.

As referred to herein, the term care of address may refer to an IP address of the mobile node's current point of attachment to the Internet.

As referred to herein, the term correspondent node may refer to a node that communicates with the mobile node. This node may be mobile or not.

As referred to herein, the term foreign agent or FA may refer to a mobility agent on the foreign network of the mobile node that provides services to the mobile node.

As referred to herein, the term foreign network may refer to a network which the mobile node is currently visiting.

As referred to herein, the term home address may refer to a permanent fixed address of the mobile node which is used by TCP and higher level layers.

As referred to herein, the term home agent or HA may refer to a mobility agent on the home network of the mobile node that maintains a mobility binding table.

As referred to herein, the term home network may refer to a network which is identified by the home address of the mobile node.

As referred to herein, the term mobile node may refer to a node that changes its point of attachment to the Internet.

As referred to herein, the term mobility agent may refer to a node that offers some services to a mobile node.

As referred to herein, the term local mobility anchor or LMA may refer to the equivalent of the home agent in a proxy MIP environment.

As referred to herein, the term mobile access gateway may refer to the equivalent of a FA in a proxy mobile IP environment.

A mobile device (e.g., a user equipment (UE)), may support two protocols, e.g., MIP and MPTCP. The mobile node referred to herein may correspond to such a mobile device that supports MIP and MPTCP.

MIP may help a mobile node to keep a TCP session connected, for example, by allowing the mobile node to have two fixed IP addresses and by transparently maintaining the binding between the two addresses. One IP address is the permanent home address that is assigned at the home network and is used to identify communication endpoints. The other IP address is a temporary care-of address (CoA) that represents the current location of the host.

MPTCP may allow the mobile node to increase capacity by using multiple paths in a regular TCP session.

Without coordination between MPTCP and MIP, the MPTCP session may over-rely on going through the HA, which may cause one or more of the following issues. The HA may become a bottleneck of the MPTCP session as TCP sub-flows may go through it. The capacity increase between the mobile node and the correspondent node may be limited between the MN and HA.

MPTCP efficiency may be improved by establishing cooperation between MPTCP and MIP. For example the systems and methods disclosed herein may establish MPCTP behavior to selectively send data over TCP subflows created on top of an active or deactivated MIP stack. This may include new API(s) between MPTCP and Mobile IP to allow MPTCP to dynamically activate/deactivate the MIP stack.

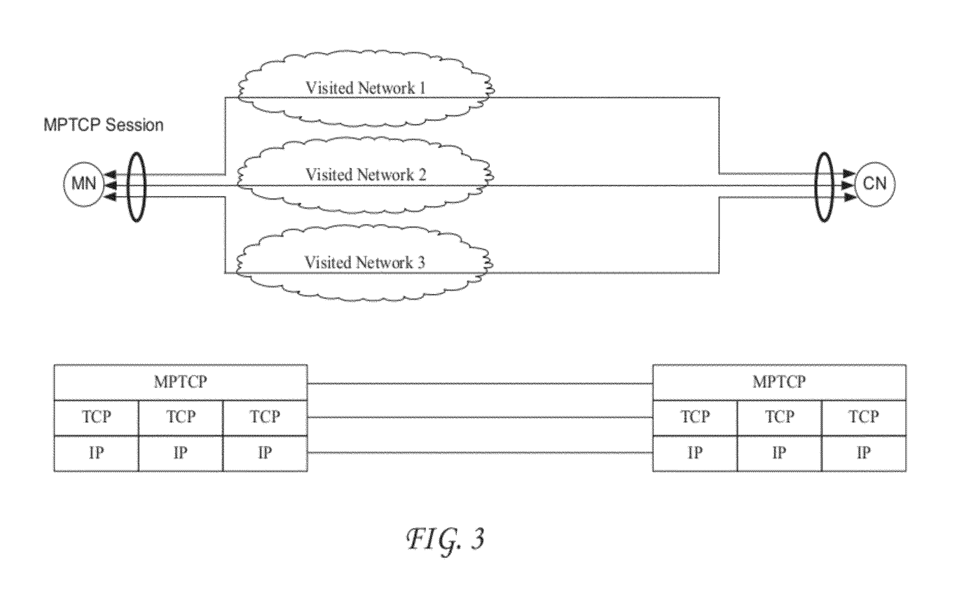

FIG. 3 illustrates an exemplary MPTCP session working with simple IP, e.g., IP that may not have embedded mobility. From an MPTCP/TCP perspective, the change of one IP address may lead to a TCP session termination based on TCP session time-out. If one TCP session terminates, MPTCP may re-distribute the related unsent traffic between the remaining TCP flows. If one IP address is available, the MPTCP session may remain. MPTCP may add some robustness to TCP for the case of simple IP. The MPTCP session may terminate if no more IP addresses are available.

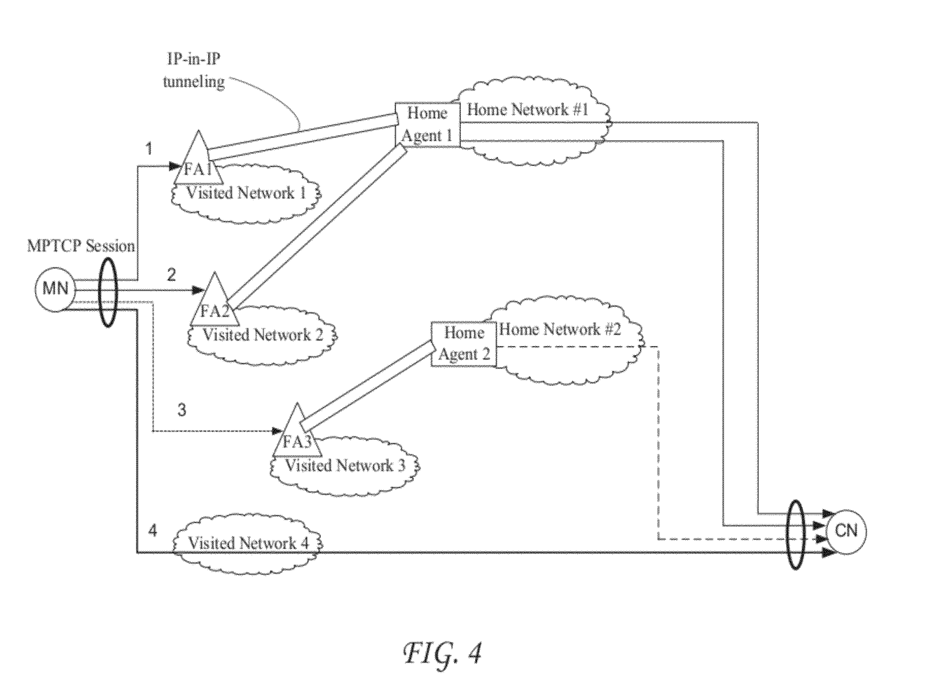

FIG. 4 illustrates an exemplary MPTCP session that includes mobile IP. The MPTCP session includes 4 sub-flows as illustrated. For subflows 1-3, the MN may be connected to the visited networks with care-of-addresses and the flows may be handled by MIP (e.g., the flows may go through a HA via MIP IP-to-IP tunneling).

Subflow 1 may be a TCP session open with the stable IP address HA1. The MN may be connected to the visited networks with CoA1 and the flows may be handled by MIP (e.g., subflow 1 may go through HA1 via MIP IP-to-IP tunneling).

Subflow 2 may be created using the stable address HA1 and may also be handled through an MIP data path. For subflows 1 and 2, it may be assumed that multiple CoAs may be supported by the same HA.

Subflow 3 may be created using the stable address HA2 and may also be handled through an MIP data path. For sub-flow 3, it may be assumed that that the MIP stack at the MN may support multiple HAs.

Subflow 4 may be a simple IP TCP flow (e.g., as described herein).

Subflows 1-3 may be seen by the CN as having an unchanged IP (e.g., HA) address, while subflow 4 may be disconnected when the MN is moving. Although the data paths of subflows 1-3 pass through HAs (e.g., HA1 or HA2) the subflows may have a direct routing to the CN.

MPTCP may present issues with mobile IP. The type of IP address may be ignored by MPTCP. If MPTCP runs on top of MIP, the HA may become a bottleneck.

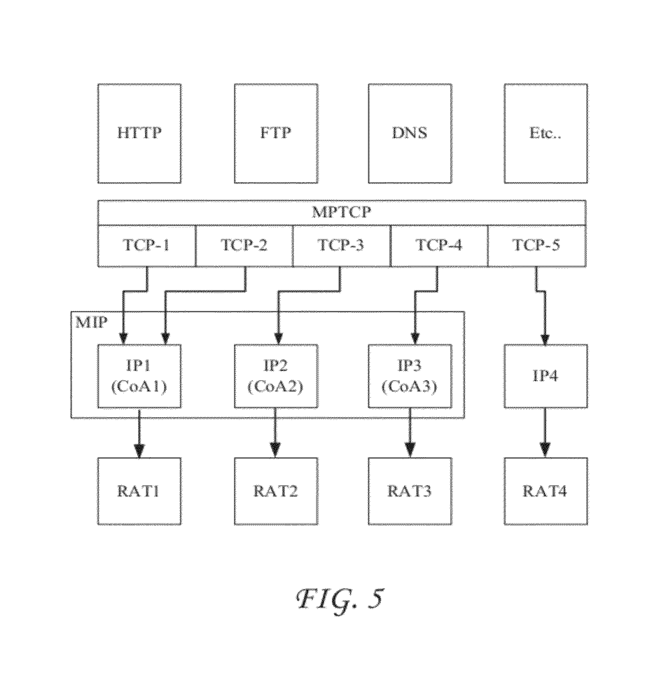

FIG. 5 illustrates an exemplary MPTCP and Mobile IP Stack. As shown in FIG. 5, MPTPC may have no knowledge about the type of IP addresses available at the host, e.g., if the IP addresses are maintained with simple IP or with MIP. In the case of an MIP address, the TCP session may be maintained through MIP mechanisms and may have lower risks of being disconnected. However, the TCP path may go through the HA via IP-in-IP tunneling, which may add overhead. With simple IP, the MN may be directly connected to the CN (e.g., without going through a home agent), but the TCP session may have a higher risk of disconnection when the MN is mobile.

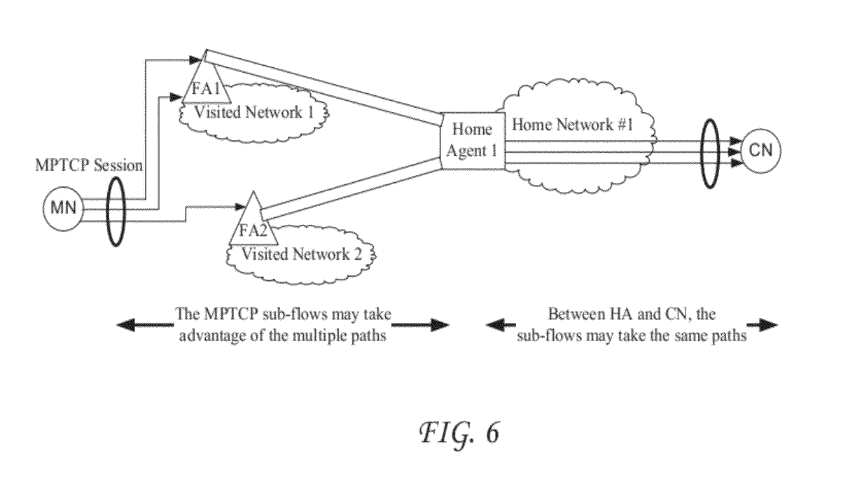

FIG. 6 illustrates an exemplary situation where an MIP HA may become a bottleneck. For HA IP addresses, if the MPTCP sub-flows are tunneled through the HA, the benefits of spreading the MPTCP sub-flows over multiple paths may not be maintained from the end-to-end (MN-CN) point-of-view. Path diversity may be limited to the paths between the MN and HAs.

The MPTCP session may be split between MIP/TCP subflows and simple IP/TCP subflows, which may be less reliable than the MIP/TCP subflows, e.g., due to the possibility of session termination relating to mobility. This split may avoid a need to send MPTCP traffic through the HA.

As an example, a first MPTCP sub-flow may be created based on MN mobility (e.g., taking advantage of the MIP feature with a constant HA). Then, additional sub-flows may be added either using MIP or simple IP. In case of a failure of the simple IP TCP session, the related flow (e.g., the related MPTCP packets which have not been acknowledged) may be re-routed to another TCP sub-flow.

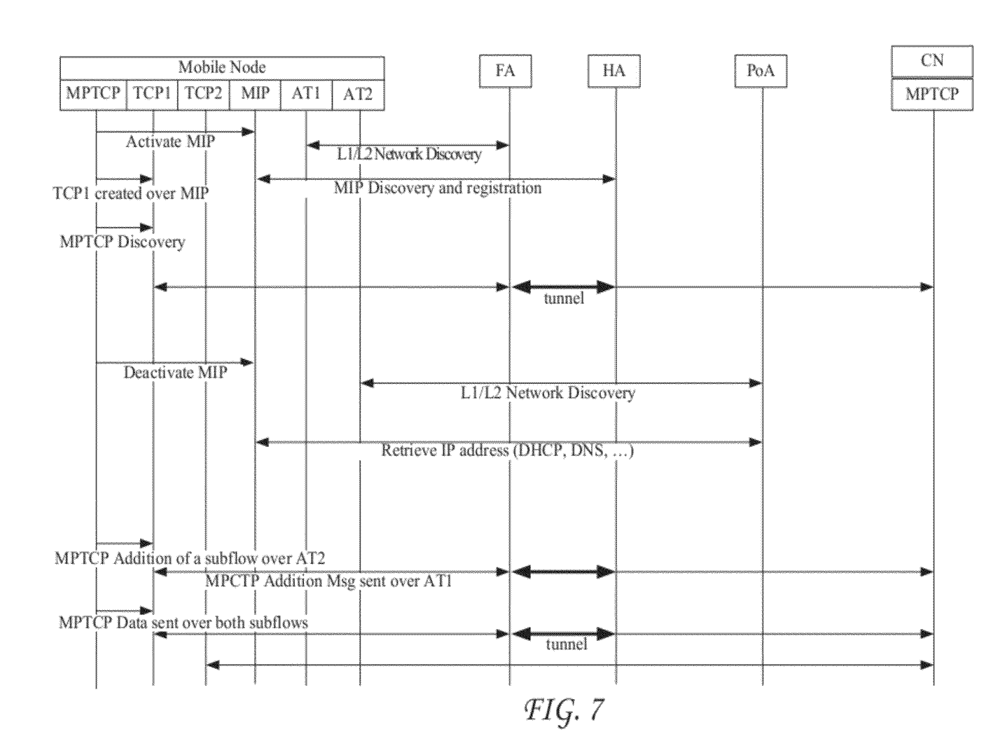

An exemplary dynamic mobile IP activation and deactivation call flow is illustrated in FIG. 7. The “Activate MIP” and “Deactivate MIP” messages may allow MPTCP to enable or disable the MIP stack. Activate MIP and Deactivate MIP messages may be implemented with functions, call back, API, etc. Through MIP Activation/Deactivation control, MPCTP may implement various strategies regarding TCP subflow creation and deletion of the MPTCP session (e.g., whether to add a subflow via MIP or simple IP).

A TCP subflow running on top of MIP may be more reliable, as it may not be discontinued by MN movement. Therefore, MPTCP may choose to send more sensitive data over these types of TCP sub-flows, such as MPTCP Control Messages (e.g. MPTCP negotiation, subflow addition, subflow deletion, etc.) or data from an application that may require a better QoS.

A TCP sub-flow created on top of deactive MIP (e.g., on top of simple IP) may be more sensitive to disconnection due to MN movement, but from a data path perspective, may be more efficient (e.g., lower RTT for instance). MPTCP may decide to send less sensitive data over these TCP subflows. In the case of a TCP subflow failure (e.g., a TCP timeout of a simple IP subflow due to mobility), the MPTCP data sent over the TCP subflows may be retransmitted over MIP TCP subflows (e.g., establishing a new subflow via MIP and transmitting the data over the new subflow). When adding a new subflow, sensitivity may be correlated to a threshold, e.g., a user or provider may indicate a level of sensitivity associated with data. If the sensitivity is above the threshold, the subflow may be established via MIP. If the sensitivity is below the threshold, the subflow may be established via simple IP.

TCP was defined in RFC 793 “Transmission Control Protocol” (September 1981), the content of which is incorporated herein by reference. Clarifications and bug fixes were provided in RFC 1122 “Requirements for Internet Hosts—Communication Layers” (October 1989), the content of which is incorporated herein by reference.

From an architecture point of view, MPTCP may need to support one or more of the following: sequence numbering—a connection level (i.e. MPTCP connection) SN and subflow (i.e. TCP flow) SN; reliability—a connection-level ack; buffering: receiving and sending buffer size; a path selector based on address pairs (source, destination); or an ID for each MPTCP connection (equivalent of TCP port number)

MPTCP may support one or more of the following: path management; packet scheduling; subflow (single-path TCP) interface; or congestion control.

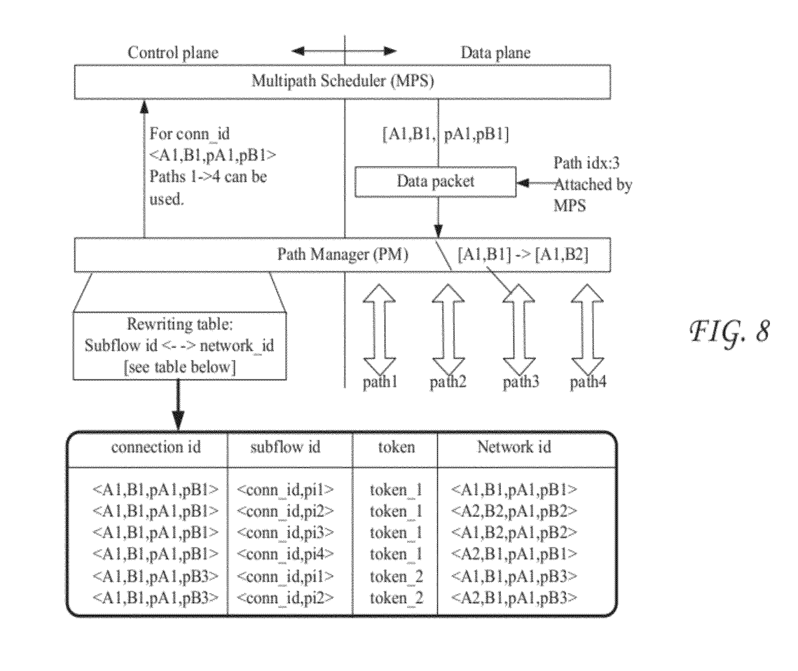

A functional architecture for MPTCP is illustrated in FIG. 8. MPTCP TCP Protocol Extensions, “TCP Extensions for Multipath Operation with Multiple Addresses” http://tools.ietforg/html/draft-ford-mptcp-multiaddressed-03 (March 2010), the content of which is incorporated herein, presents the protocol changes required by Multipath TCP, specifically those for signaling and setting up multiple paths (“subflows”), managing these subflows, reassembly of data, and termination of sessions. Protocol details may include one or more of the following.

Sequence Number—the (in-header) TCP sequence number may be subflow specific. To allow the receiver to reorder application data, an additional data-level sequence space may be used.

Receive Window—the receive window may exist at the connection level rather than at the sub-flow level.

MPTCP protocol/operation may include one or more of the following: session initiation with a multipath capable option and a data sequence number option; starting a new subflow with a join option; an address knowledge exchange (path management) with an add address option; general MPTCP operation with a data sequence mapping option; closing a connection with a DATA FIN option; error handling; or security considerations, such as a handshake to start new sub-flows that join existing connections (e.g., including a 64 bit token).

Mobility may be spread out over different layers. Disclosed herein is an overview of exemplary mobility protocols supported by each layer.

Link Layer (L2) Mobility Protocol—mobility at the link layer may not be visible at the MPTCP/TCP level. If the link layer performs handover and guarantees link reliability despite the handover, then MPTCP/TCP may not be aware of the handover.

IP (L3) Mobility Protocol—simple IP refers to the scenario where there is no mobile IP or proxy mobile IP, and a peer needs to obtain a new IP address through a standard method, such as, but not limited to, DHCP, after losing the previous IP address.

As disclosed herein, mobile IP is designed to allow each mobile node to have two IP addresses and transparently maintain the binding between the two addresses. One of the IP addresses is the permanent home address that is assigned at the home network and is used to identify communication endpoints. The other is a temporary care-of address (CoA) that represents the current location of the host. Goals of mobile IP may include making mobility transparent to the higher level protocols and to minimize changes to the existing Internet infrastructure. FIG. 1D illustrates a diagram of an exemplary Mobile IP environment.

Mobile IPv4 is described in IETF RFC 3344 “IP Mobility Support for IPv4” (August 2002), the content of which is incorporated herein by reference, and updates are added in IETF RFC 4721 “Mobile IPv4 Challenge/Response Extensions (Revised) (January 2007), the content of which is incorporated herein by reference. Mobile IPv6 is described in IETF RFC 3775 “Mobility Support in IPv6” (June 2004), the content of which is incorporated herein by reference.

From the CN, the mobile node may have a permanent IP address (home agent) and the mobile node may have a local CoA (care of address). In the case of mobility, an MIP client may need to inform the HA of the CoA change, so that the HA can re-route the packet to the new mobile node location.

Mobile IP may support mobility by transparently binding the HA of the mobile node with its CoA. This mobility binding may be maintained by some specialized routers known as mobility agents. Mobility agents may include two types—home agents and foreign agents.

The Home Agent may be a designated router in the home network of the mobile node. The Home Agent may maintain the mobility binding in a mobility binding table where each entry is identified by the tuple <permanent home address, temporary care-of address, association lifetime>, as shown in Table 1 below. This table may provide a mapping, e.g., a mobile node's home address with its care of address and forward packets accordingly.

TABLE 1
Example of a Home Agent's Mobility Binding Table

| Home Address | Care-of-Address | Lifetime (in sec) |
|---|---|---|
| 123.167.151.2 | 130.134.23.4 | 200 |
| 123.167.151.4 | 111.123.4.5 | 150 |

A foreign agent may be a specialized router on the foreign network that the mobile node is currently visiting. The foreign agent may maintain a visitor list that includes information about the mobile nodes currently visiting that network. Each entry in the visitor list may be identified by the tuple: <permanent home address, home agent address, media address of the mobile node, association lifetime>, as shown in the following table:

TABLE 2
Example of a Foreign Agent's Visitor List

| Home Address | Home Agent | | Lifetime |
|---|---|---|---|
| (CoA) | Address | MAC Address | (in sec) |
| 130.134.23.4 | 123.167.151.2 | 00-60-08-95-66-E1 | 200 |

Mobile IP protocol may include the following 4 stages: Mobile IP 1—In Service Agent Discovery; Mobile IP 2: In Service Registration; Mobile IP 3—In Service, when CN communicates with the mobile node; and Mobile IP 4—Deregistration.

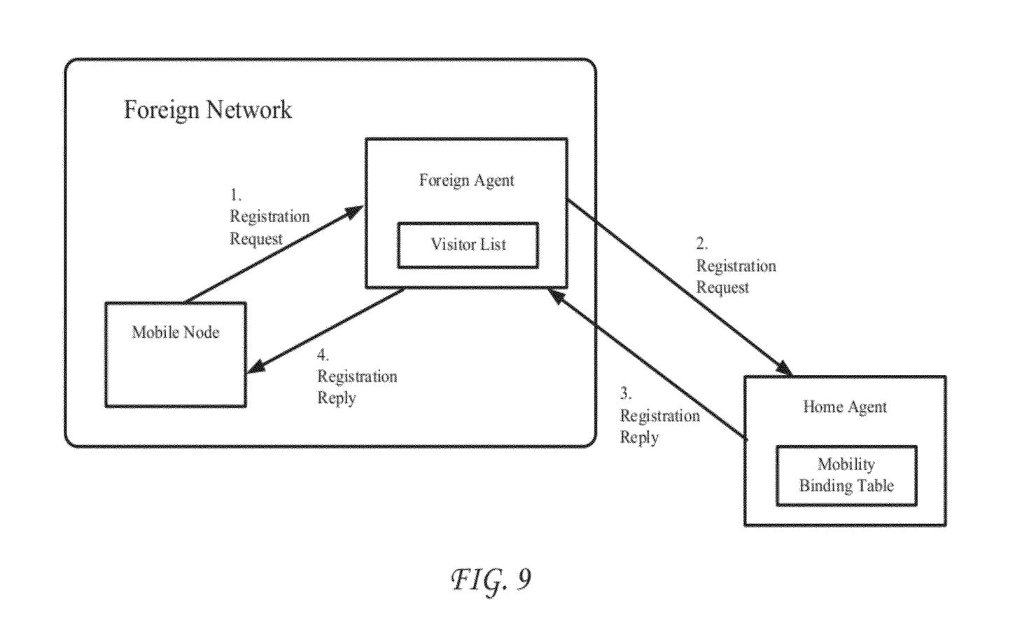

Relating to Mobile IP 2—In Service Registration, FIG. 9 is a block diagram of an exemplary mobile IP registration procedure.

Relating to Mobile IP 3—In Service, when CN communicates with the mobile node, one or more of the following may apply. When a correspondent node wants to communicate with the mobile node, it may send an IP packet addressed to the permanent IP address (HA) of the mobile node. The home agent may intercept this packet and consult the mobility binding table to find out if the mobile node is currently visiting another network. The home agent may find out the mobile node's care of address and construct a new IP header that includes the mobile node's care of address as the destination IP address. The original IP packet is put into the payload of this IP packet. It then sends the packet. This process of encapsulating one IP packet into the payload of another is known as IP-within-IP encapsulation, or tunneling. When the encapsulated packet reaches the mobile node's current network, the foreign agent may decapsulate the packet and find out the mobile node's home address. It then consults the visitor list to see if it has an entry for that mobile node. If there is an entry for the mobile node on the visitor list, the foreign agent may retrieve the corresponding media address and relay it to the mobile node. When the mobile node wants to send a message to a correspondent node, it may forward the packet to the foreign agent, which in turn may relay the packet to the correspondent node using normal IP routing. Route optimization may be part of the mobile IP initial protocol. The route optimization may allow the mobile node to send packets directly to the CN without encapsulating them and passing them through the HA. The foreign agent may continue serving the mobile node until the granted lifetime expires. If the mobile node wants to continue the service, it may need to reissue the Registration Request.

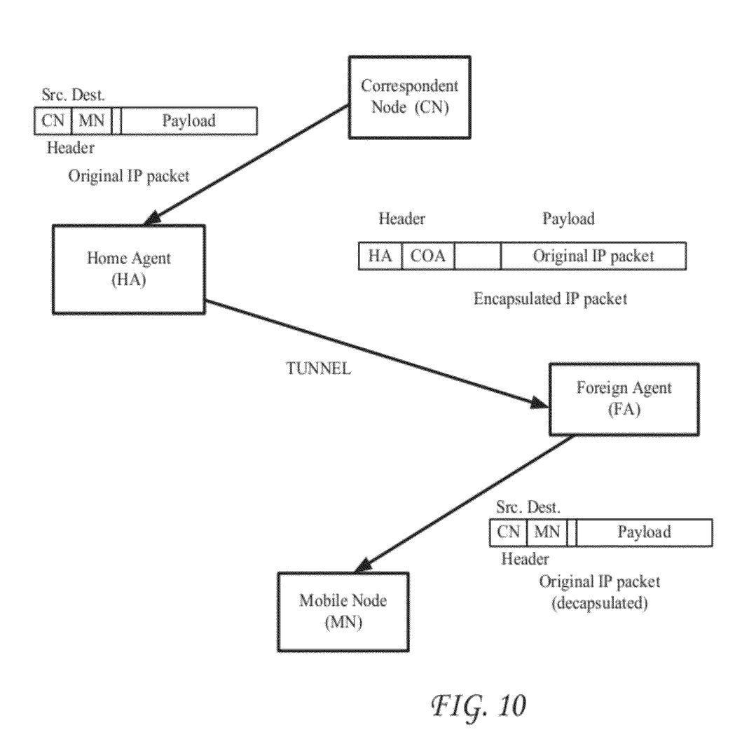

FIG. 10 is a diagram showing an example of mobile IP tunneling.

Relating to Mobile IP 4—Deregistration, if a mobile node wants to drop its care of address, it may need to deregister with its home agent.

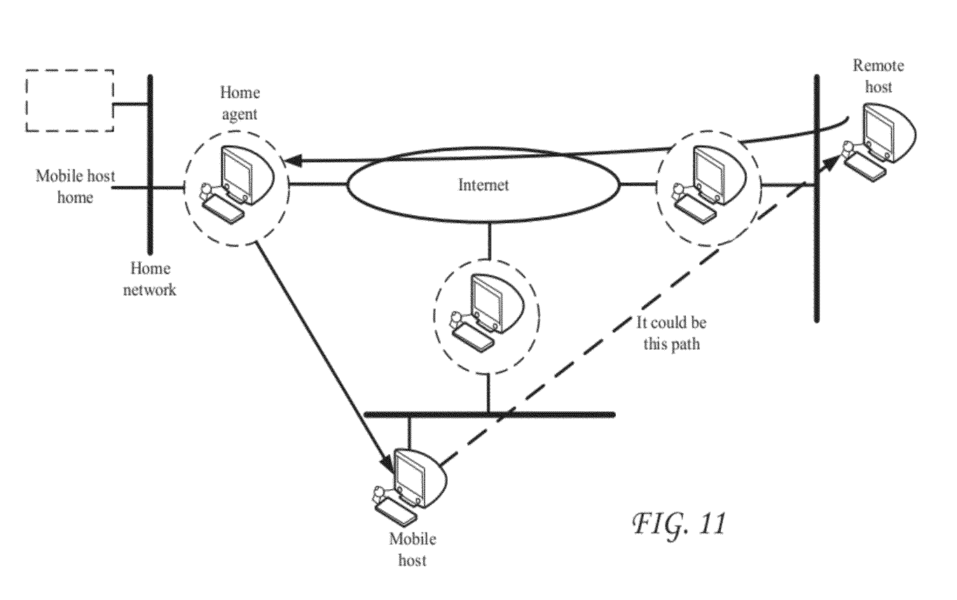

Route optimization gives a way for a node/host to maintain a binding cache (a cache of mobility bindings of mobile nodes, maintained by a node for use in tunneling datagrams to those mobile nodes) including the care of address (CoA) of one or more MN(s). When sending an IP datagram to a MN, if the sender has a binding cache entry for the destination MH, it can tunnel the datagram directly to the CoA indicated in the cached mobility binding. FIG. 11 illustrates an example of an MIP triangular routing environment.

Mobile IPv6 is described in IETF RFC 3775, which is incorporated herein by reference. IPv6 addresses are 128 bits long. Mobile IPv6 may include one or more of the following. Route optimization may be built as a fundamental part of mobile IPv6 unlike mobile IPv4 where it may be an optional set of extensions that may not be supported by all nodes. Foreign Agents may not be needed in Mobile IPv6. The enhanced features of IPv6 like Neighbour Discovery and Address Autoconfiguration may enable mobile nodes to function in a location without the services of a special router in that location. In Mobile IPv4, when a mobile node communicates with a correspondent node, it puts its home address as the source address of the packet. “Ingress filtering routers” may be used to filter out the packets as the source address of the packet is different from the network from which the packet originated. Mobile IPv6 may put the care of address as the source address and having a Home Address Destination option, allowing the use of the care of address to be transparent over the IP layer.

Disclosed herein is an architecture with MPTCP in a proxy server configuration. The current MPTCP session may be considered to be end-to-end between the MN and the CN, e.g., as illustrated in FIG. 3. FIG. 3 illustrates an exemplary end-to-end MPTCP protocol stack.

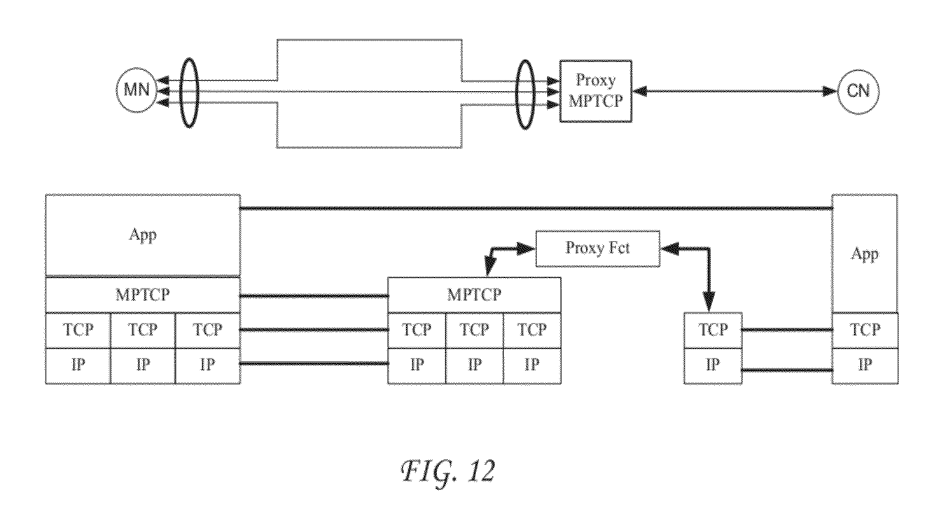

FIG. 12 illustrates an example proxy MPTCP protocol stack. Referring to FIG. 12, a proxy MPTCP may be introduced between the MN and CN. TCP Proxies may be provided in a Middle Box such as a Firewall, which may examine and analyze TCP data for security purposes. The MPTCP proxy may be a dual MPTCP/IP and TCP/IP termination device. The (Layer 5) MPTCP Proxy function may consist in the ability to terminate and proxy (i.e. receive data and forward it) to the right hand side simple TCP connection with the left hand side MPTCP connection, transparent to the client and destination endpoints. Meanwhile, it can also inspect (MP) TCP data, e.g., to perform some security verification. The MPTCP proxy may function as a proxy for simple IP and MIP, e.g., receiving simple IP and MIP subflows via the methods disclosed herein and forwarding the received data to the simple TCP connection (e.g., the CN in FIG. 12).

Terminating TCP connections may be a complex task, requiring a variety of functions such as handshaking, data segmentation, checksum generation/verification, congestion control, out-of-order reassembly and timer management. Proxy MPTCP may require session state management to track each TCP connection's status from the initial SYN/ACK three-way handshake to the closing FIN message which tears down the connection.

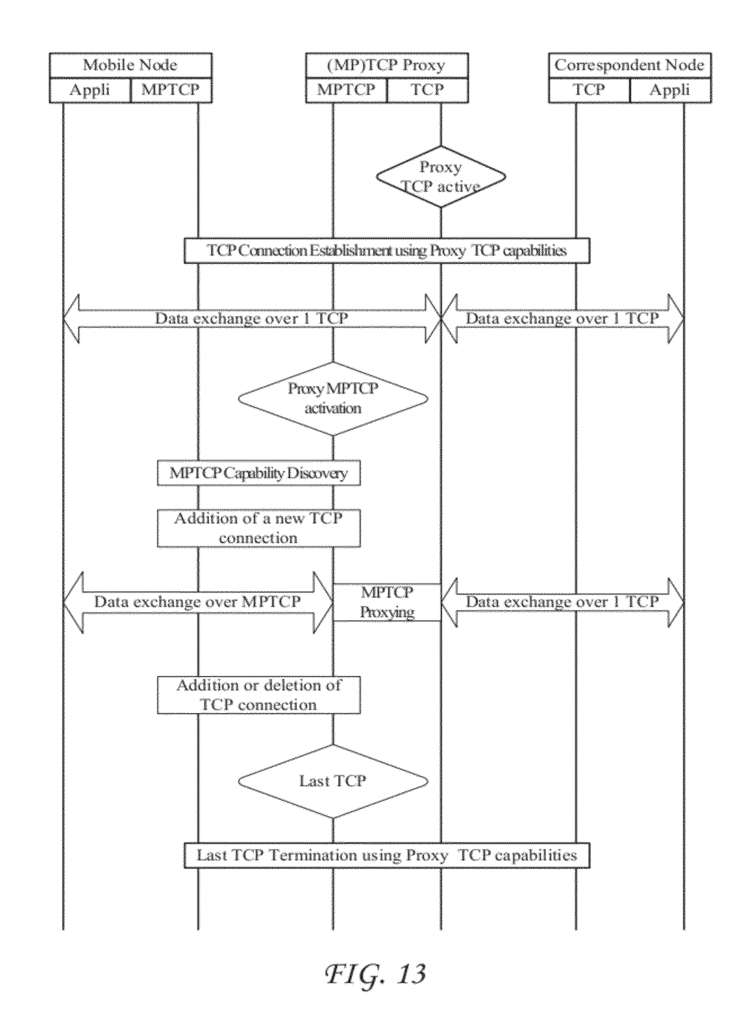

FIG. 13 illustrates a diagram of an exemplary proxy MPTCP call session. MPTCP proxying during data exchange (e.g., from MPTCP Session to TCP Connection—from left to right in the call flow diagram of FIG. 13) may extract data from the MPTCP session by removing MNTCP SNs and sending them on the TCP data buffer. In the right to left direction (i.e. from the single TCP session to MPTCP session), the MPTCP proxy may place received data into the available multiple TCP subflows and encapsulate them into an MNTP Frame by adding the appropriate SN.

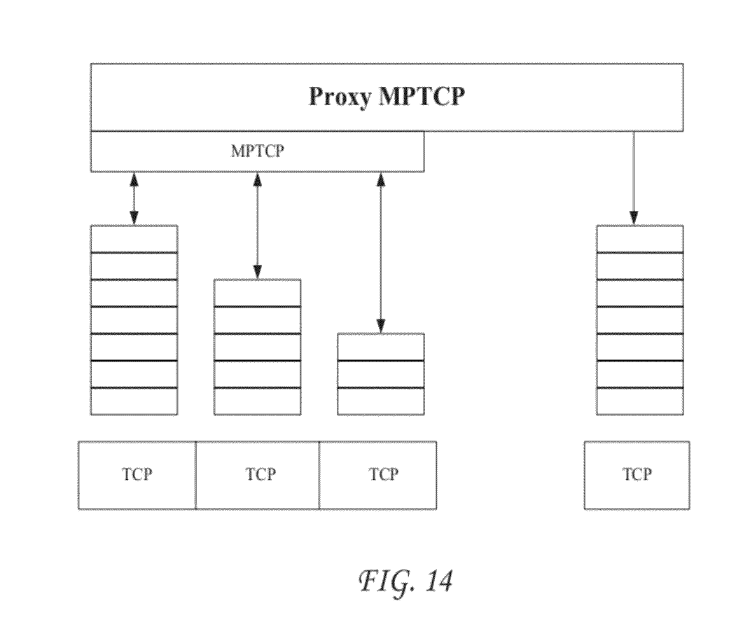

FIG. 14 illustrates an exemplary proxy MPTCP protocol stack.

What is claimed:

1. A method to route transmission control protocol (TCP) data, the method comprising:
activating a mobile internet protocol (MIP);
establishing a first subflow via the MIP, wherein the first subflow is associated with a first path;
deactivating the MIP; and
establishing a second subflow via a simple internet protocol (IP), wherein the second subflow is associated with a second path.

2. The method of claim 1, wherein the subflows are associated with a multipath transmission control protocol (MPTCP) session.

3. The method of claim 1, wherein a sensitivity of data associated with the second subflow is below a threshold.

4. The method of claim 1, further comprising:
detecting a failure associated with the second subflow;
establishing a third subflow via the MIP, wherein the third subflow is associated with a third path; and
transmitting data associated with the failure via the third subflow.

5. The method of claim 1, further comprising establishing a third subflow via the MIP, wherein the third subflow is associated with a third path, and wherein a sensitivity of data associated with the third subflow is above a threshold.

6. The method of claim 1, further comprising detecting a proxy TCP server, wherein the paths for the subflows include the proxy TCP server.

7. A mobile node configured at least in part to:
activate a mobile internet protocol (MIP);
establish a first subflow via the MIP, wherein the first subflow is associated with a first path;
deactivate the MIP; and
establish a second subflow via a simple internet protocol (IP), wherein the second subflow is associated with a second path.

8. The mobile node of claim 7, wherein the subflows are associated with a multipath transmission control protocol (MPTCP) session.

9. The mobile node of claim 7, wherein a sensitivity of data associated with the second subflow is below a threshold.

10. The mobile node of claim 7, further configured to:
detect a failure associated with the second subflow;
establish a third subflow via the MIP, wherein the third subflow is associated with a third path; and
transmit data associated with the failure via the third subflow.

11. The mobile node of claim 7, further configured to establish a third subflow via the MIP, wherein the third subflow is associated with a third path, and wherein a sensitivity of data associated with the third subflow is above a threshold.

12. The mobile node of claim 7, further configured to detect a proxy TCP server associated with a correspondent node, wherein the paths for the subflows include the proxy TCP server.
